(19) United States
(12) Patent Application Publication
(10) Pub. No.: US 2004/0245964 A1
(43) Pub. Date: Dec. 9, 2004

(54) Three phase system with controlled switching of a load network to a three phase power supply

(76) Inventor: Gerard Cornelis Schoonenberg, Hengelo (NL)

Correspondence Address: Arnold B Silverman, Eckert Seamans Cherin & Mellott, 44th Floor, 600 Grant Street, Pittsburgh, PA, 15219, US

(21) Appl. No.: 10/489,691

(22) PCT Filed: Sep. 13, 2002
(86) PCT No.: PCT/NL02/00588

(30) Foreign Application Priority Data
Sep. 14, 2001 (NL) 1018960

(51) Int. Cl. G05F 1/70

(52) U.S. Cl. 323/210

(57) ABSTRACT

Three-phase system comprising a three-phase power source and a three-pole switch, through which the phase terminals of the three-phase power source can be connected to a load network. A reference time detector is present for determining a reference point in time. A drive control circuit is provided for controlling the poles of the switch. The poles of the three-pole switch are switched at controlled times at different intervals with respect to the reference time. The time of the contact touch of the first pole is after 185° plus the maximum anticipated pre-ignition time increased by n times 180° after the zero crossing of the voltage between the first and second pole. The times of contact touch of the second pole and the third pole are respectively at n₁ times the frequency period increased by 120° and increased by n times 180° and at n₂ times the frequency period increased by 240° and increased by n times 180° after the time of contact touch of the first pole, where n is equal to zero or a whole number.

The invention relates to a three-phase system comprising a three-phase power source, a three-pole switch, through which the phase terminals of the three-phase power source can be connected to a load network, a reference time detector for determining a reference point in time, and a drive control circuit for driving the poles of the switch such that the poles of the three-pole switch are switched at controlled times at different intervals with respect to the reference time.

A device of this kind is known from laid-open German patent application DE-A-4 105 698. This known three-phase system comprises a load network that is switched onto a three-phase power source by means of a three-pole switch, the poles being switched at individual times. This extends the electrical and mechanical lifetime of the switches for all types of load and current.

It is an object of the invention to provide a three-phase system of the type mentioned in the preamble, in which the switching, even if a short-circuit exists, limits the (arc) energy generated also during the pre-ignition stage and any bounce of the contacts of the switch poles.

This object is achieved by the invention by arranging that the time of contact touch of the first pole is between 185° and 257° increased by n times 180° after the zero crossing of the voltage between the first and second pole, and that the times of contact touch of the second pole and the third pole are respectively at n, times the frequency period increased by 120° and increased by n times 180°, and at n₂ times the frequency period increased by 240° and increased by n times 18020 after the time of contact touch of the first pole, where n, n₁ and n₂ are zero or a whole number.

Preferably, the time of contact touch of the first pole is at 2 ms+1850 increased by n times 180° after the zero crossing of the voltage between the first and second pole.

Owing to the choices of times of contact touch of the poles of the switch mentioned above, the (arc) energy generated, even when all possible types of short-circuit exist, is limited. Moreover, the invention prevents the main contacts from becoming welded together. The risk of re-ignition at the next disconnection is reduced.

In addition, the invention has the following advantages:

less wear, therefore can be switched into short circuits much more often, and even repeatedly.

superior dielectric behaviour after switching into a short circuit (no deformed contacts—points out of contacts).

in combination with controlled disconnection, a smaller vacuum contact breaker can meet the same specifications.

Preferred embodiments are defined in the subclaims.

Hereafter, the invention shall be explained with reference to the following drawings:

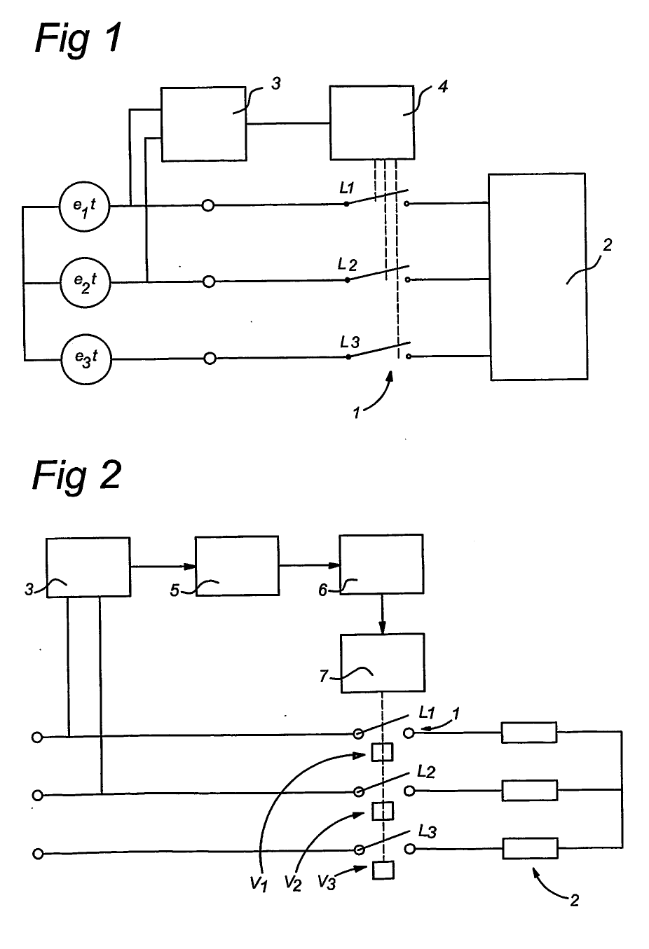

FIG. 1 shows a schematic of the priniciples of a three-phase system according to the invention;

FIG. 2 shows an embodiment of the three-phase system according to the invention; and

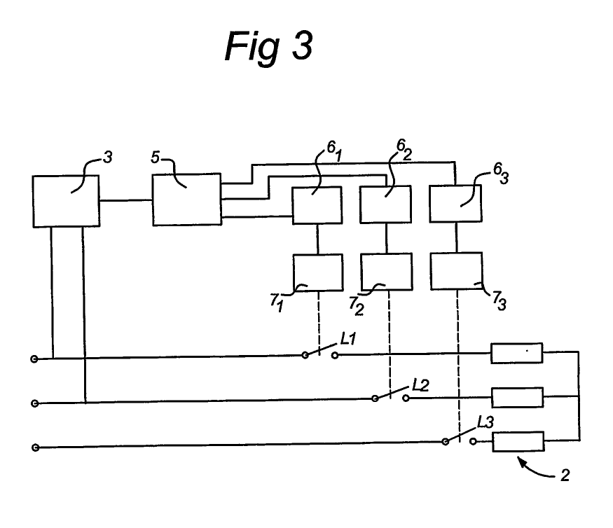

FIG. 3 shows another embodiment of the three-phase system according to the invention.

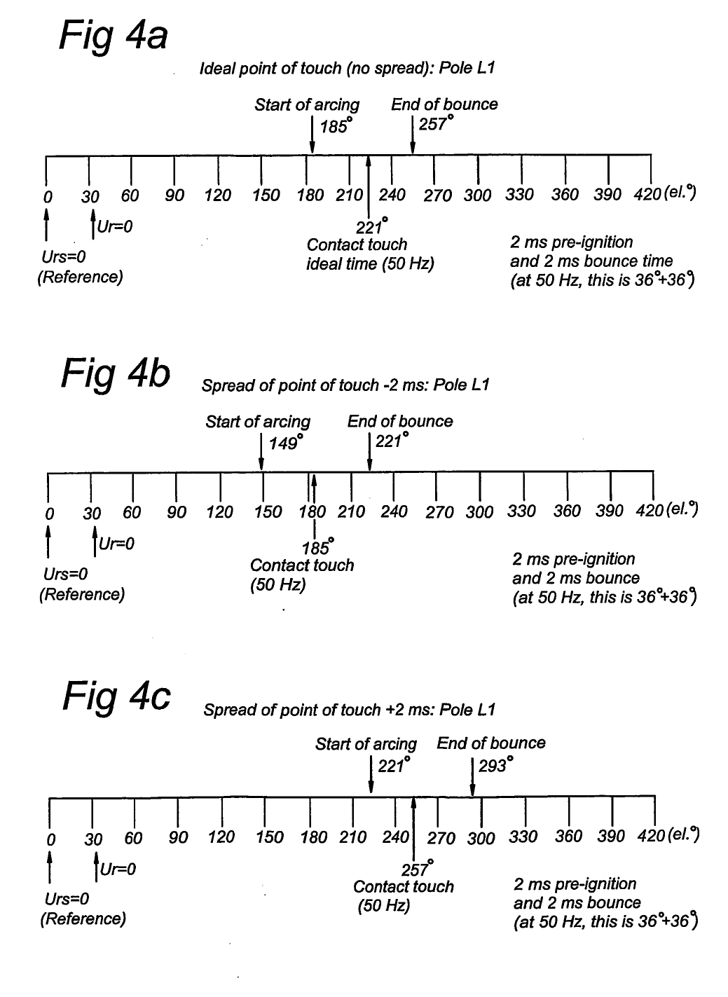

FIG. 4a, 4b and 4c show possible points in time of contact touch of pole L1.

FIG. 1 shows the principle of a three-phase system that comprises a three-phase power source e₁t, e₂t, e₃t and a load network 2 that can be connected to the phase terminals of the three-phase power source via a three-pole switch 1 with poles L1, L2 and L3. Moreover, the three-phase system includes a zerocrossing detector 3 which is connected between two phase terminals, for example phase terminals L1 and L2 of the three-phase power source elt, e₂t, e₃t. This detector determines the zero crossings of the voltage between the two abovementioned phase terminals and, based on a point in time of a zero crossing, controls the drive control circuit 4 that drives the poles L1, L2 and L3 of the three-pole switch 1. Notable here is that the use of a zero-crossing detector connected between the phase terminals L1 and L2 is preferred as a reference time detector. However, any detector can be used, such as a peak detector for example. Moreover, the detector can be connected between 1 phase and earth, or between 2 other phases. The important point is that there is a reference to the primary voltage. Measuring between 2 phases always gives a good and unambiguous result and is therefore preferred. For another reference point, the hereafter named times or angles of contact are, of course, used. The hereafter named times and angles are based on the zero-crossing detector being connected between the phases L1 and L2, therefore U_{L1-L2}=0

The three-phase system can, for example, be a known three-phase medium voltage system (approximately 1-50 kV), which is equipped with vacuum switches as a three-pole switch. The invention is suitable for both load and power switches. In the three-phase system, in particular in the load network, an undetected short circuit can occur. While switching into such a short circuit, it is important to adrnit minimal energy in the arc during (unavoidable) preignition to avoid possible welding together of the contacts. This can be achieved by switching with maximum asymmetry because in the relevant area of time of approx. 2 ms, the increase in current is still minimal. Moreover, pre-ignition will then be minimal, because the voltage is then zero, as is the case with an inductive load network. Since in the event of a short circuit the network will have an inductive character, in this situation the same requirements as those noted above will apply.

A contradictory requirement to that given above is that for minimum operational power between the phases, asymmetric currents must be prevented as much as possible. This requirement is considered less strict and therefore not set here. The network must in any case already be specified for a maximum asymmetric short circuit current, since short circuit can also occur in another way, whereby the full peak is reached.

Asymmetry is reached because poles L1, L2 and L3 are switched at controlled times. In order to assume one reference that satisfies all cases occurring (including therefore a floating supply with an already existing earth fault in the switch), a phase-phase voltage is considered, for example the voltage between the phase terminals L1 and L2. In particular, a zero-crossing detector 3 is used that in the given example has its input terminals connected to the phase terminals L1 and L2 and at its output gives a signal that represents a zero crossing. With this output signal of the zero-crossing detector 3, the drive control circuit 4 is controlled, the drive control circuit 4 and the corresponding poles L1, L2 and L3 interacting such that the time of contact touch or the switching time of the first pole (L1) is after 185° increased by n times 180° after the zero crossing and that the times of contact touch of the second pole L2 and third pole L3 are 120° increased by n times 180° and 240° increased by n times 180° after the time of contact touch of the first pole, where n is equal to zero or a whole number. Apart from the time difference given here between the times of contact touch of the second or third poles, the time difference can, if necessary and if desired, be increased flurher by n₁ times the frequency period for the second or n₂ times the frequency period for the third pole. Because the times are interrelated, n₂ in the chosen example should not be smaller than n1. This can be different, of course, in a different network situation such as a different phase sequence. Furthermore, here also n1 and n2 can be zero or a whole number. In practice, n₁ and n₂ will be zero because in general it will as far as possible be attempted to approach synchronous switching of the three poles.

In the following, by way of example, a situation will be explained assuming a star earthed network in which the best choice for the closing sequence of the poles L1, L2, L3 will be given as follows:

contact touch of pole L1 after max. 2 ms+185° with respect to the reference time, namely the zero crossing of the voltage between two phases, in this case U_{L1-L2}=0, (optional: wait n₁ times the frequency period)

switch the pole L2 with a delay of 120° with respect to the pole L1 (optional: wait n₂ times the frequency period)

switch the pole L3 with a delay of 240° with respect to the pole L1. In this context, account is taken of a pre-ignition time of max. 2 ms and a bounce time of max. 2 ms. With a shorter pre-ignition time, contact touch can also take place at x+185°, where x is identical to the shorter ignition time.

The best choice for closure sequence for a floating network is identical to that of a star earthed network.

In table A, a comparison of controlled switching (including the effects of ±1 ms and ±2 ms spread in the mechanism) is given with respect to conventional simultaneous switching. A short-circuit current of 25 kA is assumed.

The most important criterion is the amount of energy during the arcing phase, expressed as I².t or in the case of a constant arc voltage as I.t.

It is apparent from table A that the time constant τ of the network has hardly any influence on that criterion at least so long as realistic values for τ are taken. The standard IEC value (τ=45 ms) is therefore sufficient to calculate furter. As “worst case” in table A, 2 ms pre-ignition +2 ms bounce is assumed. Of course, shorter times have a more favourable effect here on (arc) energy (lower I².t and I.t values). The angle given gives the start of the pre-ignition and applies for 50 Hz. Two ms later, the contacts of pole L1 touch. Table A is given as an example for 50 Hz. For other frequencies, e.g. 60 Hz, the same behaviour is observed. With times remaining equal for spreads in the time control pre-ignition and bounce, other angles apply for 60 Hz. For two ms with 50 Hz this is 360, but with 60 Hz it is 43.20. With 60 Hz, different (somewhat higher) I².t and I.t values are also reached. The influence of controlled switching, however, is also still positive for 60 Hz.

Therefore, when account is taken of variations caused by the mechanical spread and by the accuracy of the time control of a maximum of 2 ms, the time of contact touch of the first pole L1 is between 185° and 185°+4 ms. With this variation, controlled switching is still advantageous. With variations significantly larger than + or −2 ms, there is little point in controlled switching. With shorter pre-ignition times or shorter bounce times, the effect of controlled switching becomes even more favourable, because there is less (arc) energy generated between the contacts.

FIG. 4a gives the ideal time of contact touch for the first pole (L1). There is no mechanical spread, so account is only taken of the maximum pre-ignition time of 2 ms or 36 electrical degrees and the maximum bounce time of 2 ms or 36 electrical degrees.

The point of contact is then at 221°.

When account is taken of a mechanical spread of a maximum +2 ms and −2 ms, the ideal point of contact will be displaced.

FIG. 4b gives the point of touch when the mechanism is switched on 2 ms too early, whereby the point of contact is at 185°.

FIG. 4c gives the point of touch when the mechanism is switched on 2 ms too late, whereby the point of contact is at 257°.

In all three situations, however, the period within which the arc energy can manifest itself is limited to a maximum of 4 ms or 72 electrical degrees, and this “window” will shift forwards or backwards in time as a result of the mechanical spread.

For 50 Hz, the point of contact touch of pole L1 is therefore between 1850 and 257° after the zero crossing (U_{L1-L2}=0).

The point of contact touch for pole L2 for 50 Hz is between 84° and 156°, and for pole L3 with 50 Hz between 204° and 276°. As has been noted, these are points in time of contact touch of the poles L2 and L3 in relation to pole L1, and the points in time can, if necessary, still be lengthened by a number of periods.

TABLE A

| τ (ms) | 45 | (IEC) | 32 | | 106 | | |
|---|---|---|---|---|---|---|---|
| Ref. U_{L1-L2} = 0 | I²t(KA)²s | I.t(As) | I²t(KA)²s | I.t(As) | I²t(KA)²s | I.t(As) | |
| Conventional | 2.3 | 83.3 | 2.2 | 82.5 | 2.4 | 84.6 | |
| max. (95°) | | | | | | | |
| Controlled | <0.05 | 10.6 | <0.05 | 10.6 | <0.05 | 10.6 | |
| ideal (185°) | | | | | | | |
| +1 ms (203°) | 0.3 | 24.7 | 0.3 | 24.6 | 0.3 | 24.9 | Influence |
| −1 ms (167°) | 0.2 | 27.1 | 0.2 | 26.7 | 0.2 | 27.6 | of |
| +2 ms (221°) | 0.9 | 47.9 | 0.9 | 47.5 | 0.9 | 48.4 | mechanical |
| −2 ms (149°) | 0.7 | 50.1 | 0.7 | 49.5 | 0.8 | 51.0 | spread |

Influence of controlled switching with 25 kA short-circuit

There are two possibilities for controlling the poles of the switch. Firstly, there is a drive with mechanical graduations at 1200 (pole L2) and 240° (pole L3): so at 50 Hz this would correspond to 6.7 and 13.3 ms. The other possibility consists of 3 independent drives, each switching 1 pole.

FIG. 2 shows a first embodiment with mechanical delay between the phases L1, L2 and L3.

A zero-crossing detector 3 detects the zero crossings of the voltage between the L1 and L2 phases. The output signal of the zero-crossing detector 3 is transmitted to the central processing unit 5 which determines from the zero-crossing signals, the times at which the actuator drive control or buffer 6 is activated. This actuator drive control or buffer 6 controls actuator 7 which in turn switches poles L1, L2 and L3 of the three-pole switch 1. The contact touch of poles L1, L2 and L3 of the switch are influenced by mechanical delays V₁, V₂ and V₃, the delay periods of which also ensure that the poles L1, L2 and L3 are switched at the times mentioned above. V₁ governs the delay of L₁, V₂ the delay of L2, and V₃ the delay of L3. It is preferable to limit the delays to two, with one governing the delay between L1 and L2, and the other the delay between L2 and L3.

FIG. 3 shows an embodiment with electronic delay between the phases. In this embodiment too, a zero-crossing detector 3 and a central processing unit 5 are used. The central processing unit 5 has three outputs to which three actuator drive controls or buffers 61, 62 and 63 are connected, the outputs of this being connected to the inputs of the actuators 7₁, 7₂ and 7₃, which control poles L1, L2 and L3. The delay can be implemented electronically somewhere in the circuit from the central processing unit up to and including the actuators 71, 72 and 73. V₁ governs the delay of L₁, V₂ of L2, and V₃ of L3. The delays can be limited to two, with one governing the delay between L1 and L2, and the other the delay between L2 and L3.

Owing to the choices of the points of contact touch mentioned above, a maximum asymmetric short-circuit current will exist, with the result that the thermal load of the power switch is minimal. It is therefore possible without difficulty to switch on the short-circuit current even more often or to choose a smaller design. The maximum delay for the three poles is preferably always smaller than 1 period (20 ms at 50 Hz), and therefore of no importance to the user.

1. Three-phase system comprising a three-phase power source, a three-pole switch, through which the phase terminals of the three-phase power source can be connected to a load network, a reference time detector for determining a reference point in time and a drive control circuit for driving the poles of the switch such that the poles of the three-pole switch are switched at controlled times at different intervals with respect to the reference time, characterised in that the time of the contact touch of the first pole (L1) is between 185° and 257° increased by n times 180° after the zero crossing of the voltage between the first and second pole (L1, L2) and in that the times of contact touch of the second pole (L2) and the third pole (L3) are respectively at n₁ times the frequency period increased by 120° and increased by n times 180°, and at n₂ times the frequency period increased by 240° and increased by n times 180° after the time of contact touch of the first pole (L1), where n, n₁ and n₂ are zero or a whole number.

2. Three-phase system according to claim 1, characterized in that the time of contact touch of the first pole (L1) is at 2 ms+185° increased by n times 180° after the zero crossing of the voltage between the first and second pole (L1, L2).

3. Three-phase system according to claim 1, but characterized in that the time of contact touch of the first pole (L1) is in the range 185° to 185°+4 ms increased by n times 180° after the zero crossing of the voltage between the first and second pole (L1, L2) and in that the times of contact touch of the second pole (L2) and third pole (L3) are respectively in the range of n₁ times the frequency period increased by 120°-2 ms to n₁ times the frequency period increased by 120°+2 ms and increased by n times 180° and in the range of n₂ times the frequency period increased by 240°−2 ms to n₂ times the frequency period increased by 240°+2 ms and increased by n times 180° after the time of contact touch of the first pole (L1), where n, n₁, and n₂ are zero or a whole number.

4. Three-phase system according to claim 1, 2 or 3, characterized in that the reference time detector is a zero-crossing detector that is connected between the two phases (L1, L2).

5. Three-phase system according to one of the previous claims, characterized in that the poles of the three-pole switch are provided with mechanical delays and the values of the delays correspond to the time intervals associated with the switching times of the poles.

6. Three-phase system according to one of the previous claims, characterized in that the drive control circuit controlling the switching of the poles of the three-pole switch is provided with an electronic delay and the values of the delays correspond to time intervals associated with the switching times of the poles.
